(19) United States
(12) Patent Application Publication
(10) Pub. No.: US 2013/0200592 A1
(43) Pub. Date: Aug. 8, 2013

(54) Boat Transport Dolly Limited to Boats With Overhanging Gunwales

(71) Applicant: Edwin H. Corlett, LaGrange Park, IL (US)

(72) Inventor: Edwin H. Corlett, LaGrange Park, IL (US)

(21) Appl. No.: 13/368,463

(22) Filed: Feb. 8, 2012

(51) Int. Cl. B60P 3/10

(52) U.S. Cl. 280/414.2

(57) ABSTRACT

The sailboat transport dolly provides a simple means of moving boats even if they have a mounted sail. It requires no attachments or modifications to the boat but it requires that the boat have overhanging gunwales. The dimensions of the dolly are determined by the class of boats it is built to serve. The dolly is unique in that it easily loads the boat so long as it is sitting upright on the supporting surface. It does this by straddling the boat and leveraging it off the supporting surface by engaging the boat's overhanging gunwales. The wheels are positioned to be forward of the boat's center of balance when leveraged off the supporting surface causing the boats bow to rise and be contained by the front of the dolly. The dolly can also be folded for easy storage.

### BACKGROUND OF THE INVENTION

1. Field of the Invention

The invention relates to a boat dolly which allows a person to quickly and easily transport and launch a sailboat.

2. Description of the Prior Art

Many different types of boat dollies have been patented over the past years for transporting boats. Most of them are designed to support the bottom of the boat which makes it difficult to load the boat on the dolly because it involves lifting the boat onto the dolly. U.S. Pat. Nos. 5,261,680 and 6,189,478, attach to the boat gunwales which obviates the need to lift the boat onto the dolly which is an improvement over the bottom support dolly. However, these patents require either a modification to the boat (U.S. Pat. No. 5,261,680) or the ability to clamp from both sides of the gunwale (U.S. Pat. No. 6,189,478) which is not required by this invention. Also, if installed on a sailboat, these devices would hinder the operation of the sailboat by interfering with the centerboard and sail sheets while this invention would not.

### SUMMARY OF THE INVENTION

The boat dolly of the present invention addresses the problem mentioned in prior art by providing a means for transporting and launching a sailboat without lifting it onto the dolly or requiring any modifications or attachments to the boat. In its use, it is limited to boats with, overhanging gunwales which are common on many small sailboats. The overhanging gunwales, which extend out sideways from the hull, provide the means whereby the dolly can lift the boat. The dolly straddles the boat so that it can be rolled quickly into position to lift the boat, even if the boat has a mast with a sail installed, with two lifting devices that engage the overhanging gunwales. If the boat dolly lifting devices are forward of the boat's center of balance, the boat's bow will be supported by the forward end of the boat dolly designed to be atop the boat bow when the boat is loaded on the dolly. If the boat dolly lifting devices are aft of the boat's center of balance, the boat's bow needs be supported by either belaying the boat painter to the boat dolly handle or providing a hook attached to the boat dolly that can engage an element on the boat.

### BRIEF DESCRIPTION OF THE DRAWINGS

FIG. 1 is an elevation side view of the boat dolly supporting a sailboat with its sail up.

FIG. 2 is a top view of FIG. 1 with the sail of the sailboat removed for clarity.

FIG. 3 is an elevation side view of the boat dolly.

FIG. 4 is a top view of FIG. 3.

FIG. 5 is an enlarged rear view of FIG. 4.

FIG. 6 is an elevation rear view of FIG. 1 with the sailboat sail perpendicular to the sailboat.

FIG. 7 is a detailed view of the boat dolly lifting device engaging the boat's overhanging gunwale.

FIG. 8 depicts the boat dolly in position to load the sailboat.

FIG. 9 depicts what happens when the lifting devices are aft of the boat's center of balance.

FIG. 10 depicts how the situation in FIG. 9 can be corrected by belaying the boat's painter to the boat dolly handle.

FIG. 11 is a detailed enlarged view of an alternative way to correct the situation depicted in FIG. 9.

FIG. 12 depicts the result of using the alterative way depicted in FIG. 11.

FIG. 13 is a rear view of the boat dolly detailing how it can be collapsed for storage.

FIG. 14 is an elevation side view of the boat dolly detailing how it can be collapsed for storage.

FIG. 15 is an elevated side view of the boat dolly collapsed.

FIG. 16 is a top view of FIG. 15.

### DESCRIPTION OF THE PREFERRED EMBODIMENT

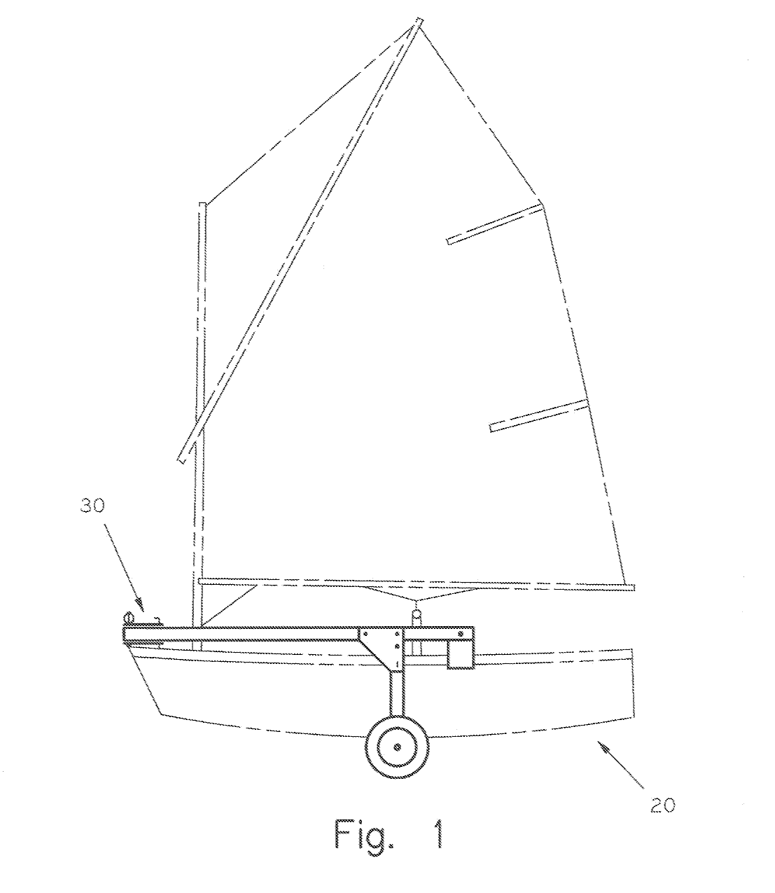

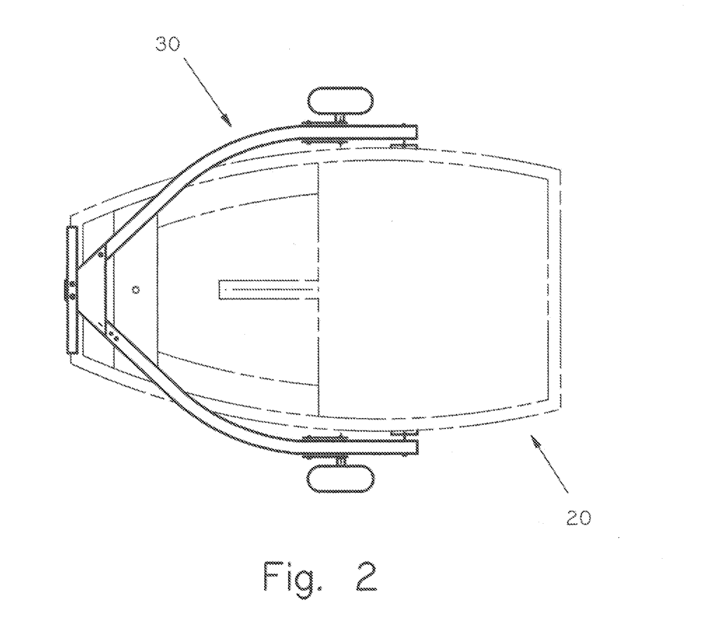

The invention shown in FIGS. 1 thru 15 is a boat dolly limited to use with boats having overhanging gunwales. The boat that the dolly will support determines the dimensions of the dolly. For illustration, the Optimist Dinghy, which is a very popular sailboat, has been chosen as the boat used in describing this invention. FIGS. 1 and 2 show the boat 20 supported by the dolly 30, ready to be easily moved from one location to another. Note how the dolly 30 straddles the boat 20 so that the boat 20 can be a sailboat with a mast, there are no attachments to the boat 20 and the boat is stable on the dolly 30 because the dolly 30 is configured so that the wheels 35 and 36 are forward of the boat's center of balance and the boat's bow is contained by downward pressure of the forward part of the dolly 30.

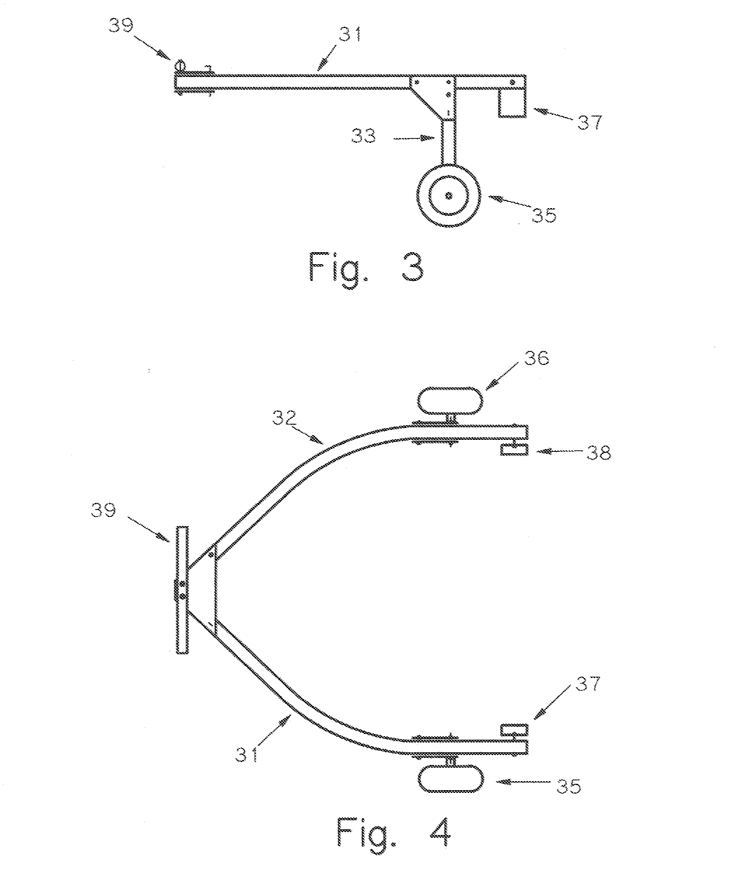

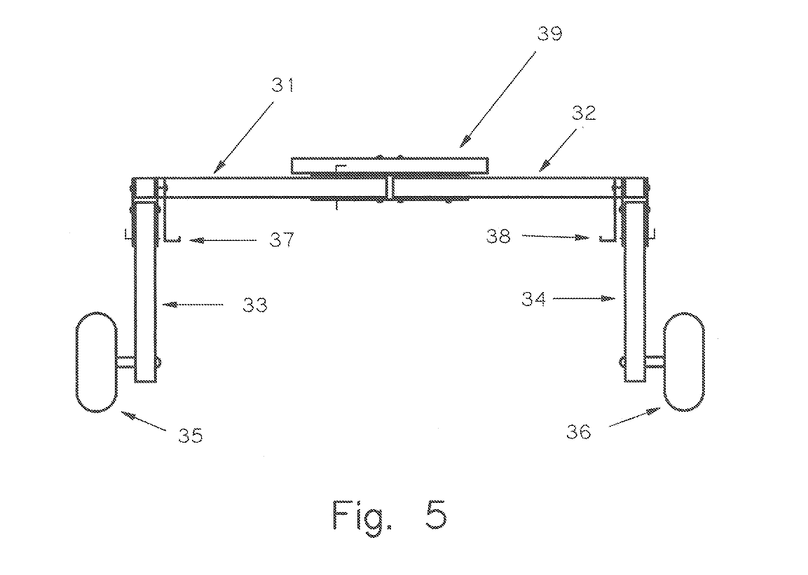

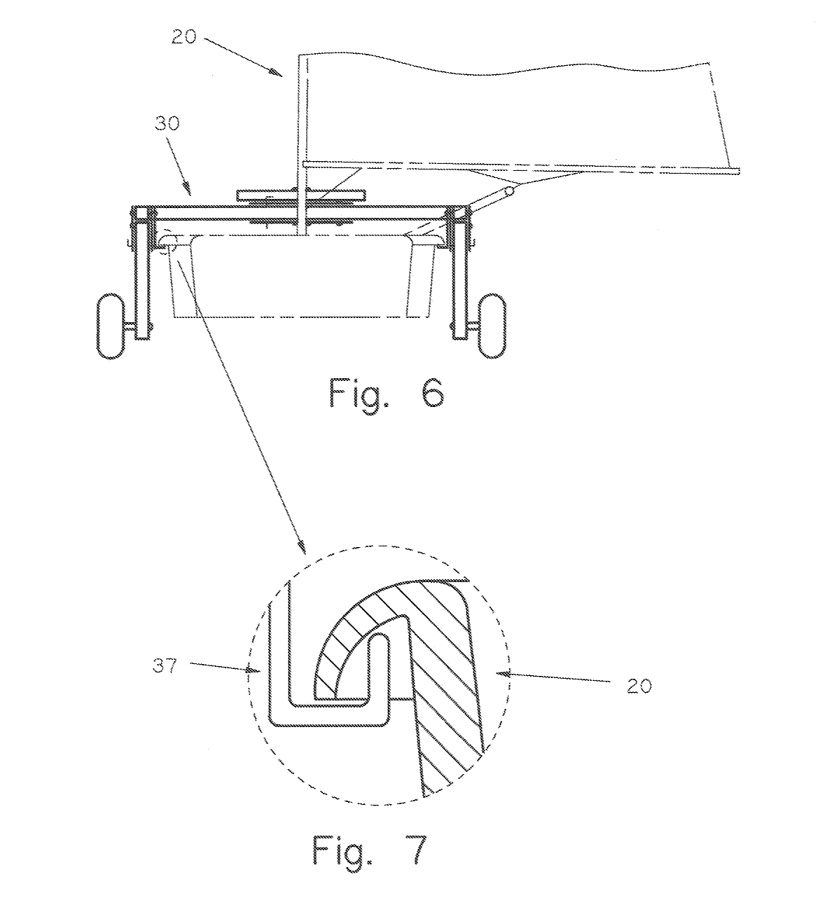

FIGS. 3, 4 and 5 show the elements making up the dolly. These elements can be built with materials known by those skilled in the art like steel, aluminum, fiberglass, wood, etc. and in different shapes such as round, oblong, tubular or solid. Square aluminum has been chosen in this representation. The frame of the dolly has two fore and aft elements, the right fore and aft element 31 and the left fore and aft element 32, which are square aluminum tubes that are rigidly joined together at their forward ends with aluminum plates. These tubes are rigidly joined so as to extend out obliquely until they are separated by more than the width of the boat and then pre bent to become parallel so as to straddle the boat. This allows the forward portion of the frame to align over the bow of the boat while the remaining portion of the frame straddles the boat. Attached to the frame are wheel struts which are square aluminum tubes the same size as the frame tubes with wheels attached that allow the frame to be moved easily while supporting the boat. The right wheel strut 33 is rigidly attached to the right fore and aft element 31 with aluminum plates so that it extends perpendicularly downward and has a right wheel 35 rotatably attached to its bottom end with the wheel's axle mounted perpendicular to the fore and aft elements of the frame and with the wheel 35 mounted on the outside of the frame so as to not interfere with the boat when being supported by the dolly. The left wheel strut 34 is rigidly attached to the left fore and aft element 32 with aluminum plates so that it extends perpendicularly downward and has a left wheel 36 rotatably attached to its bottom end with the wheel's axle mounted perpendicular to the fore and aft elements of the frame and with the wheel 36 mounted on the outside of the frame so as to not interfere with the boat when being supported by the dolly. Pivotally attached to the rear or aft end of the fame elements 31 and 32 are lifting devices for lifting the boat by its gunwales. The right lifting device 37 is mounted on the inside of the right fore and aft element 31 and the left lifting device 38 is mounted on the inside of the left fore and aft element 32 so that they can engage the boat gunwales on their respective sides. A handle 39 is attached to the forward end of the dolly where the fore and aft elements join so as to provide an easy way to guide the dolly. FIGS. 6 and 7 show in detail how the right lifting device 37, which is shown as an aluminum hook, engages the boat 20 overhanging gunwale.

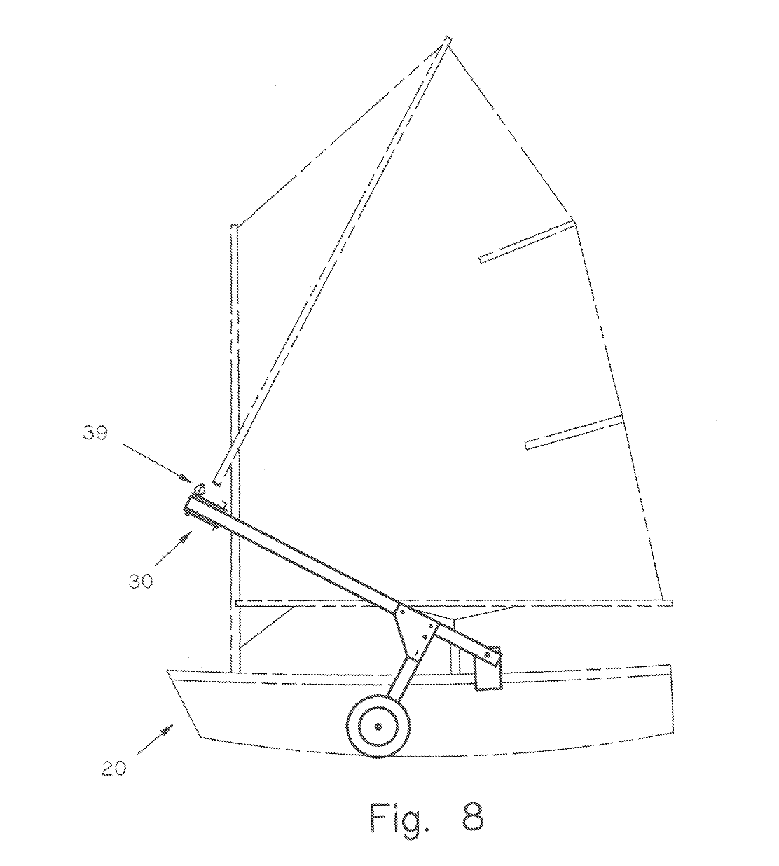

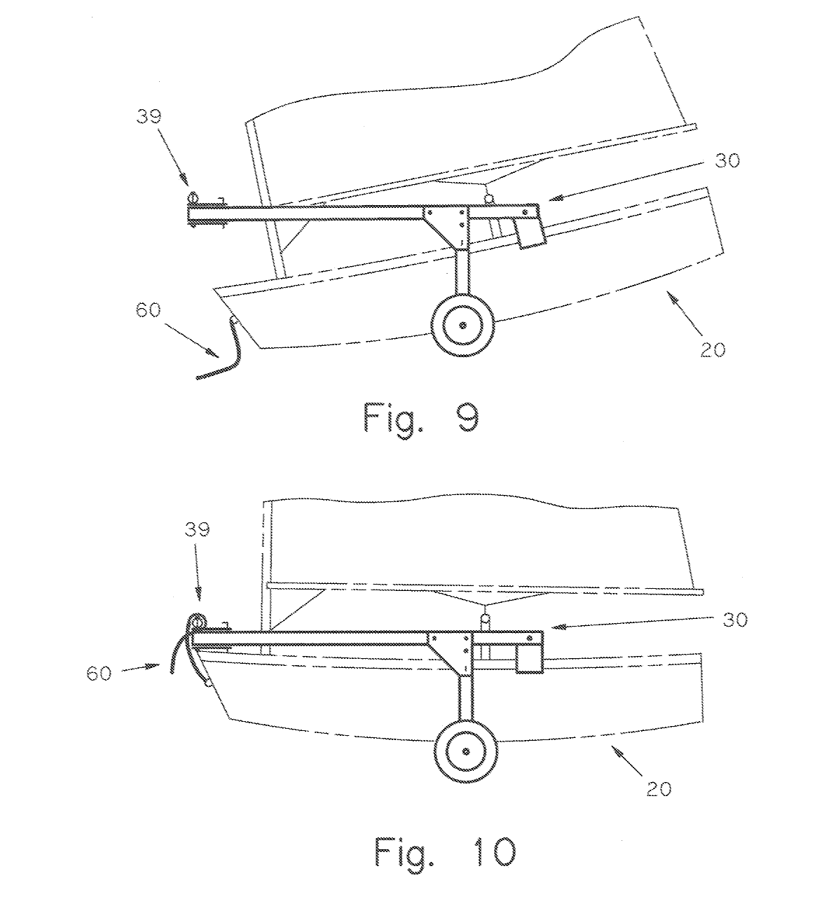

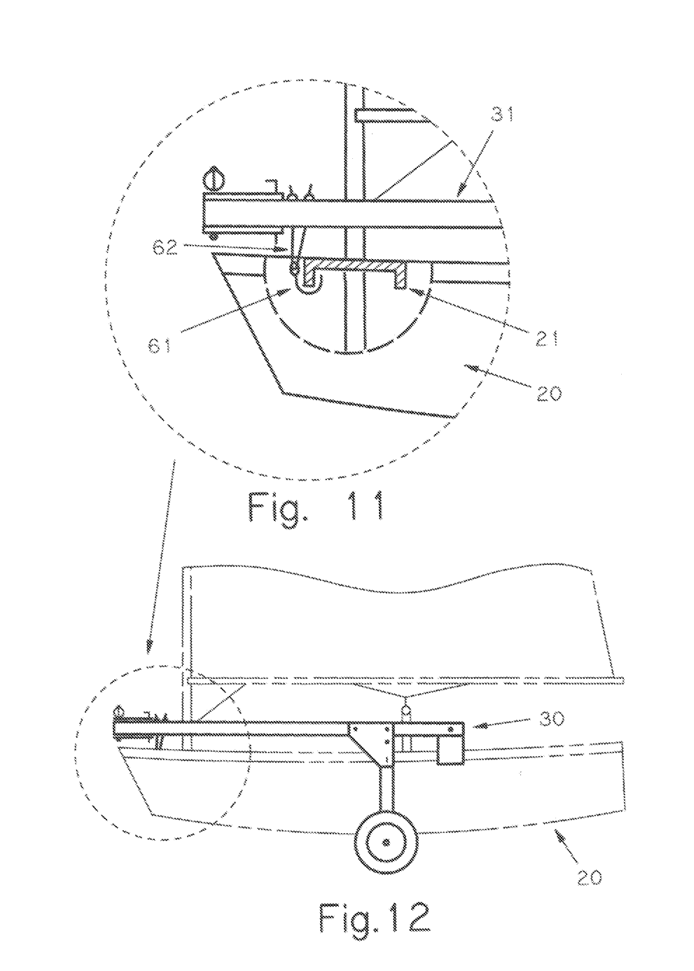

FIG. 8 shows the dolly 30 in position to lift the boat 20 off the supporting surface. Lowering the handle 39 so that the dolly 30 frame is horizontal accomplishes one of two things depending on if the wheel 35 and 36 axles are in front or behind the center of balance of the boat 20. If the axles are in front of the center of balance of the boat 20, the boat 20 will assume the position shown in FIG. 1. If not, FIG. 9 shows the opposite condition. Obviously, FIG. 1 is the desired condition and the dolly 30 should be designed to meet this condition but, depending on the placement of items in the boat 20, the condition in FIG. 9 can occur. To counteract this condition, a means of stabilizing the boat 20 bow must be added. This is easily done if the boat 20 has a painter 60 as shown in FIG. 9. The painter 60 can be belayed to the dolly handle 39 thereby allowing the boat 20 bow to be supported by the dolly 30 as shown in FIG. 10. If the boat 20 does not have a painter 60, an alternative stabilizing device can be provided. FIG. 11 depicts such a device consisting of a hook 61, attached to the right fore and aft element 31 with a short line 62, engaging a structural component 21 of the boat 20 thereby supporting the boat 20 as shown in FIG. 12.

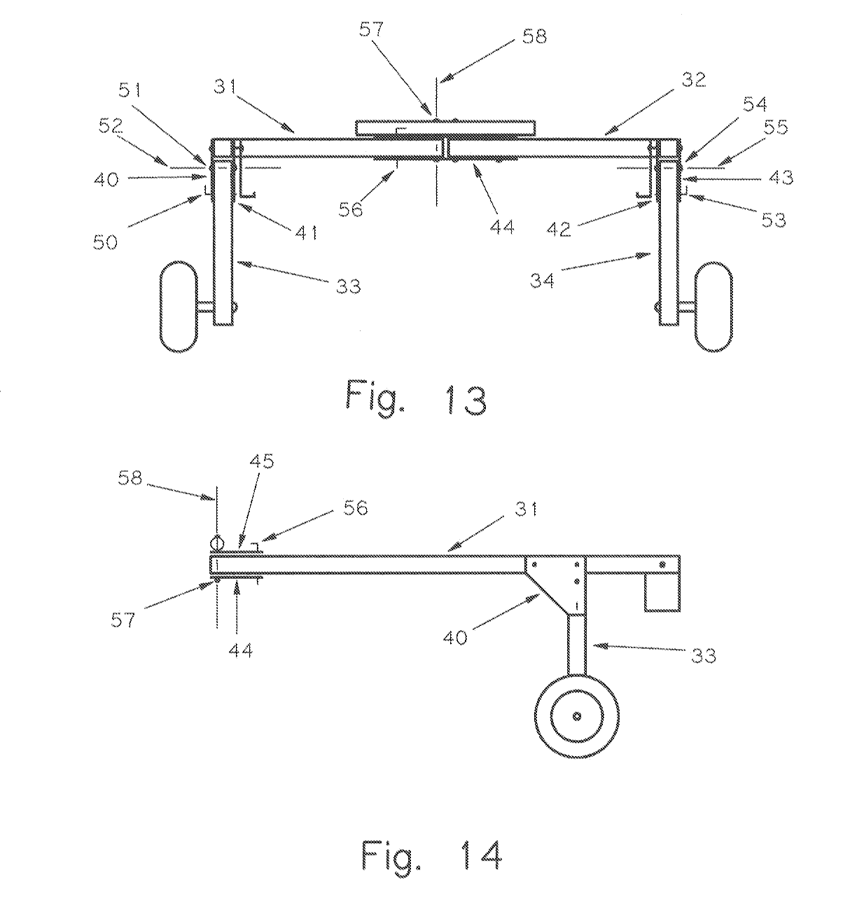

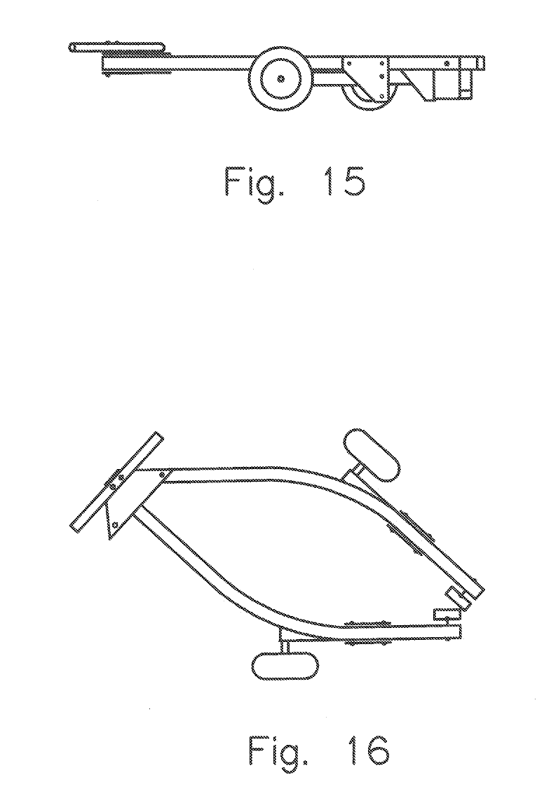

FIGS. 13 and 14 show how some elements of the dolly can be folded to reduce the size of the dolly for storage. The right wheel strut 33 is attached rigidly to the right fore and aft element 31 by identical plates, 40 and 41, pivot pin 51 and removable restricting pin 60. Removal of restricting pin 50 allows the right wheel strut 33 to fold up to right fore and aft element 31 with centerline 52 as the center of rotation. The left wheel strut 34 is attached rigidly to the left fore and aft element 32 by identical plates, 42 and 43, pivot pin 54 and removable restricting pin 53. Removal of restricting pin 53 allows the left wheel strut 34 to fold up to right fore and aft element 32 with center line 55 as the center of rotation. The right fore and aft element 31 is attached rigidly to the left fore and aft element 32 by identical plates, 44 and 45, pivot pin 57 and removable restricting pin 56. Removal of restricting pin 56 allows the right fore and aft element 31 to fold into the left fore and aft element 32 with center line 58 as the center of rotation. FIGS. 15 and 16 show the dolly folded for storage.

I claim:

1. A boat dolly for manually transporting a boat having opposed overhanging gunwales, comprising:
a frame, supported by right and left wheels, comprising right and left elements which are joined only at their forward ends and shaped to straddle the boat so that with the boat in an upright position, the frame can be rolled into the position of straddling the boat even if the boat has a mast,
a right lifting device affixed to the right element positioned to engage the underside of the gunwale overhang on its respective side of the boat,
a left lifting device affixed to the left element positioned to engage the underside of the gunwale overhang on its respective side of the boat, and
a means of stabilizing the boat when being supported by the two lifting devices.

2. A boat dolly as recited in claim 1, wherein the right and left elements are respectively composed of right and left fore and aft elements with right and left wheel struts attached to their respective fore and aft element extending downward with the right and left wheels rotatably attached to their respective wheel strut on a rotational axis perpendicular to the fore and aft elements in such a way as to provide rolling transport of the boat.

3. A boat dolly as recited in claim 2, wherein the fore and aft elements, with a handle affixed at their joined fore ends, extend out obliquely until their separation is wider than the boat width whereupon the fore and aft elements redirect to become generally parallel thereby straddling the boat so as to allow the wheel struts and wheels to straddle the boat and the wheels be aligned with the boat fore and aft axis.

4. A boat dolly as recited in claim 3, wherein the lifting devices are located along their respective fore and aft elements and the wheel struts are of adequate length and positioned in such a way forward of the lifting devices that when the handle is raised sufficiently and the dolly rolled into position straddling the boat the lifting devices will engage the boat gunwale overhang.

5. A boat dolly as recited in claim 4, wherein the lowering of the handle will cause the boat's fore end to be lifted off the boat's supporting surface and the means of stabilizing the boat will be the fact that the boat dolly fore end is atop the boat's fore end restraining it from lifting thereby causing the boat's aft end to be lifted off the boat's supporting surface thereby lifting the whole boat off its supporting surface allowing the boat to be easily rolled to a new location.

6. A boat dolly as recited in claim 4, wherein the lowering of the handle will cause the boat's aft end to be lifted off the boat's supporting surface and the means of stabilizing the boat will be the belaying of the boat's painter to the dolly handle so as to support the boat's fore end when the handle is lifted thereby lifting the whole boat off its supporting surface allowing the boat to be easily rolled to a new location.

7. A boat dolly as recited in claim 4, wherein the lowering of the handle will cause the boat's aft end to be lifted off the boat's supporting surface and the means of stabilizing the boat will be a stabilizing device attached to the dolly forward of the wheel struts that can engage a boat element so as to support the boat's fore end when the handle is lifted thereby lifting the whole boat off its supporting surface allowing the boat to be easily rolled to a new location.

8. A boat dolly as recited in claim 7, wherein the stabilizing device is a hook attached to a fore and aft element with a short line and where the boat element is an overhang in the boat.

9. A boat dolly as recited in claim 4, wherein the fore and aft elements are comprised of square tubing, the handle is comprised of a tube attached where the fore and aft elements join and perpendicular to the fore and aft axis of the dolly, the lifting devices are comprised of elongated hooks pivotally attached to the fore and aft elements, the wheel struts are comprised of tubing the same size as the fore and aft elements and project perpendicularly downward from their respective fore and aft elements.

10. A boat dolly as recited in claim 4, wherein the fore and aft elements are pivotally joined but restricted from pivoting by a removable restricting pin and the wheel struts are pivotally attached to the fore and aft elements but restricted from pivoting by removable restricting pins so that by removing the restricting pins, the boat dolly can be folded to a smaller size.
